(19) United States
(12) Patent Application Publication
(10) Pub. No.: US 2022/0311278 A1
(43) Pub. Date: Sep. 29, 2022

(54) FREE POSITIONING MULTI-DEVICE WIRELESS CHARGER

(71) Applicant: AIRA, INC., Chandler, AZ (US)

(72) Inventors: Eric Heindel Goodchild, Phoenix, AZ (US); Magne Nerheim, Paradise Valley, AZ (US); Simon McElrea, Chandler, AZ (US); Aleksandar Petrovic, Phoenix, AZ (US); Mohammad Ali Saket Tokaldani, Vancouver (CA); James Scott, Chandler, AZ (US)

(21) Appl. No.: 17/703,978

(22) Filed: Mar. 24, 2022

Related U.S. Application Data
(60) Provisional application No. 63/166,964, filed on Mar. 26, 2021.

(51) Int. Cl. H02J 50/12; H02J 50/40; H02J 50/60; H02J 50/90; H02J 50/80

(52) U.S. Cl. CPC H02J 50/12; H02J 50/402; H02J 50/60; H02J 50/90; H02J 50/80

(57) ABSTRACT

Systems, methods and apparatus for wireless charging are disclosed. A wireless charging device has a plurality of planar power transmitting coils, a coil substrate and a driver circuit. Each planar power transmitting coil may be formed as a spiral winding surrounding a power transfer area. In one example, each planar power transmitting coil is formed by spiral winding a multi-strand wire, each strand in the multistrand wire being electrically insulated from each other strand in the multi-strand wire. The coil substrate may have a plurality of cutouts formed therein. The plurality of cutouts may be configured to secure the planar power transmitting coils in a preconfigured three-dimensional arrangement. The driver circuit may be configured to provide a charging current to one or more of the planar power transmitting coils when a chargeable device is placed on or near the wireless charging device.

### PRIORITY CLAIM

This application claims priority to and the benefit of provisional patent application No. 63/166,964 filed in the United States Patent Office on Mar. 26, 2021 and the entire content of this application is incorporated herein by reference as if fully set forth below in its entirety and for all applicable purposes.

### TECHNICAL FIELD

The present invention relates generally to wireless charging of batteries, including batteries in mobile computing devices, and more particularly to improving efficiency of wireless power transmission using planar Litz transmitting coils.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to support continually increasing complexity of mobile devices and changing form factors and to support new uses of wireless charging devices. For example, there is a need for charging devices that provide higher power with greater efficiency.

### BRIEF DESCRIPTION OF THE DRAWINGS

FIG. 1 illustrates an example of a charging cell that may be provided on a charging surface provided by a wireless charging device in accordance with certain aspects disclosed herein.

FIG. 2 illustrates an example of an arrangement of charging cells provided on a single layer of a segment of a charging surface provided by a wireless charging device that may be adapted in accordance with certain aspects disclosed herein.

FIG. 3 illustrates an example of an arrangement of charging cells when multiple layers of charging cells are overlaid within a segment of a charging surface provided by a wireless charging device that may be adapted in accordance with certain aspects disclosed herein.

FIG. 4 illustrates the arrangement of power transfer areas provided by a charging surface of a charging device that employs multiple layers of charging cells configured in accordance with certain aspects disclosed herein.

FIG. 5 illustrates a wireless power transmitter that may be provided in a charger base station in accordance with certain aspects disclosed herein.

FIG. 6 illustrates a first topology that supports matrix multiplexed switching for use in a wireless charging device adapted in accordance with certain aspects disclosed herein.

FIG. 7 illustrates a second topology that supports direct current drive in a wireless charging device adapted in accordance with certain aspects disclosed herein.

FIG. 8 illustrates a charging cell layout configured in accordance with certain aspects of this disclosure.

FIG. 9 illustrates an example of a Litz transmitting coil configured in accordance with certain aspects of this disclosure.

FIG. 10 illustrates an example of a portion of a charging surface provided multiple overlapping Litz coils in accordance with certain aspects of this disclosure.

FIG. 11 illustrates a charging surface of a wireless charging device constructed from Litz coils in accordance with certain aspects of this disclosure.

FIG. 12 illustrates certain aspects of a Litz coil substrate provided in accordance with certain aspects of this disclosure.

FIG. 13 provides a transparent view of Litz coils maintained within a Litz coil substrate in accordance with certain aspects of this disclosure.

FIG. 14 illustrates placement of a Litz coil within a substrate in accordance with certain aspects of this disclosure.

FIG. 15 illustrates examples of substrate configurations that can provide mechanical keying mechanisms in accordance with certain aspects of this disclosure.

FIG. 16 illustrates one example of an apparatus employing a processing circuit that may be adapted according to certain aspects disclosed herein.

FIG. 17 illustrates a method for configuring a charging device in accordance with certain aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Overview

Certain aspects of the present disclosure relate to systems, apparatus and methods associated with wireless charging devices that provide a free-positioning charging surface using multiple transmitting coils or that can concurrently charge multiple receiving devices. In one aspect, a controller in the wireless charging device can locate a device to be charged and can configure one or more transmitting coils optimally positioned to deliver power to the receiving device. Charging cells may be provisioned or configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

In one aspect of the disclosure, each charging cell in a plurality of charging cells may be constructed using Litz wire to form a planar or substantially flat winding that provides a Litz coil with a central power transfer area. Each charging cell may include or be associated with multiple Litz coils that have coaxial or overlapping power transfer areas. The plurality of charging cells may be arranged adjacent to the charging surface of the charging device without overlap of the charging cells.

In one example, a wireless charging device has a plurality of planar power transmitting coils, a coil substrate and a driver circuit. Each of the plurality of planar power transmitting coils may be formed as a spiral winding surrounding a power transfer area. In one example, each planar power transmitting coil is formed by spiral winding a multi-strand wire, each strand in the multi-strand wire being electrically insulated from each other strand in the multi-strand wire. The coil substrate may have a plurality of cutouts formed therein. The plurality of cutouts may be configured to secure the plurality of planar power transmitting coils in a preconfigured three-dimensional arrangement. The driver circuit may be configured to provide a charging current to one or more of the plurality of planar power transmitting coils when a chargeable device is placed on or near the wireless charging device.

Charging Cells

According to certain aspects disclosed herein, a charging surface in a wireless charging device may be provided using charging cells that are deployed adjacent to a surface of the charging device. In one example the charging cells are deployed in one or more layers of the charging surface in accordance with a honeycomb packaging configuration. A charging cell may be implemented using one or more coils that can each induce a magnetic field along an axis that is substantially orthogonal to the surface charging of the charging adjacent to the coil. In this description, a charging cell may refer to an element having one or more coils where each coil is configured to produce an electromagnetic field that is additive with respect to the fields produced by other coils in the charging cell and directed along or proximate to a common axis. In this disclosure, a coil in a charging cell may be referred to as a charging coil, a transmitting coil, a Litz coil or using some combination of these terms.

In some implementations, a charging cell includes coils that are stacked along a common axis and/or that overlap such that they contribute to the magnetic field that is induced substantially orthogonal to the surface of the charging device. In some implementations, a charging cell includes coils that are arranged within a defined portion of the surface of the charging device and that contribute to an induced magnetic field within the defined portion of the charging surface, the magnetic field contributing to a magnetic flux flowing substantially orthogonal to the charging surface. In some implementations, charging cells may be configurable by providing an activating current to coils that are included in one or more dynamically-defined charging cell. For example, a wireless charging device may include multiple stacks of coils deployed across a charging surface, and the wireless charging device may detect the location of a device to be charged based on proximity to one or more stacks of coils. The charging device may select some combination of the stacks of coils to define or provide a charging cell adjacent to the device to be charged. In some instances, a charging cell may include, or be characterized as a single coil. However, it should be appreciated that a charging cell may include multiple stacked coils and/or multiple adjacent coils or stacks of coils. The coils may be referred to herein as charging coils, wireless charging coils, transmitter coils, transmitting coils, power transmitting coils, power transmitter coils, or the like.

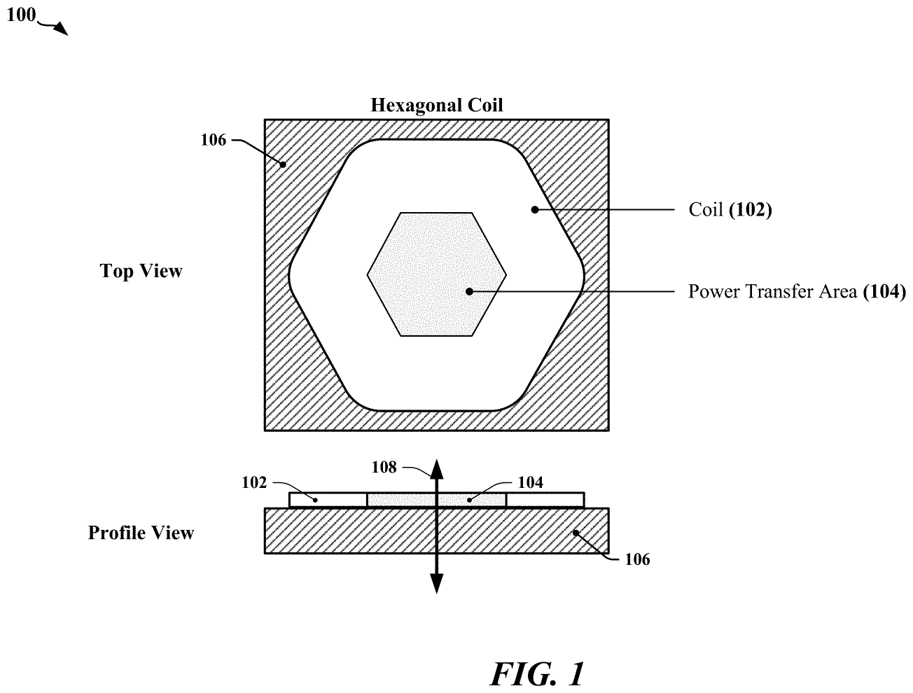

FIG. 1 illustrates an example of a charging cell 100 that may be deployed and/or configured to provide a charging surface of a wireless charging device. In this disclosure, a charging surface may be understood to include an array of charging cells 100 provided on one or more substrates 106. A circuit comprising one or more integrated circuits (ICs) and/or discrete electronic components may be provided on one or more of the substrates 106. The circuit may include drivers and switches used to control currents provided to coils used to transmit power to a receiving device. The circuit may be configured as a processing circuit that includes one or more processors and/or one or more controllers that can be configured to perform certain functions disclosed herein. In some instances, some or all of the processing circuit may be provided external to the charging device. In some instances, a power supply may be coupled to the charging device.

The charging cell 100 may be provided in close proximity to an outer surface area of the charging device, upon which one or more devices can be placed for charging. The charging device may include multiple instances of the charging cell 100. In one example, the charging cell 100 has a substantially hexagonal shape that delimits or encloses one or more coils 102. Each coil may be constructed using conductors, wires or circuit board traces that can receive a current sufficient to produce an electromagnetic field in a power transfer area 104. In various implementations, some coils 102 may have an overall shape that is substantially polygonal, including the hexagonal charging cell 100 illustrated in FIG. 1. In some implementations, one or more coils may have a flat spiral shape or a shape that is substantially circular. Other implementations provide coils 102 that are circular or elliptical in form or that have some other shape. The shape of the coils 102 may be determined at least in part by the number of windings in each coil, capabilities or limitations of fabrication technology, and/or to optimize layout of the charging cells on a substrate 106 such as a printed circuit board substrate. Each coil 102 may be implemented using wires, printed circuit board traces and/or other connectors in a spiral configuration. Each charging cell 100 may span two or more layers separated by an insulator or substrate 106 such that coils 102 in different layers are centered around a common axis 108.

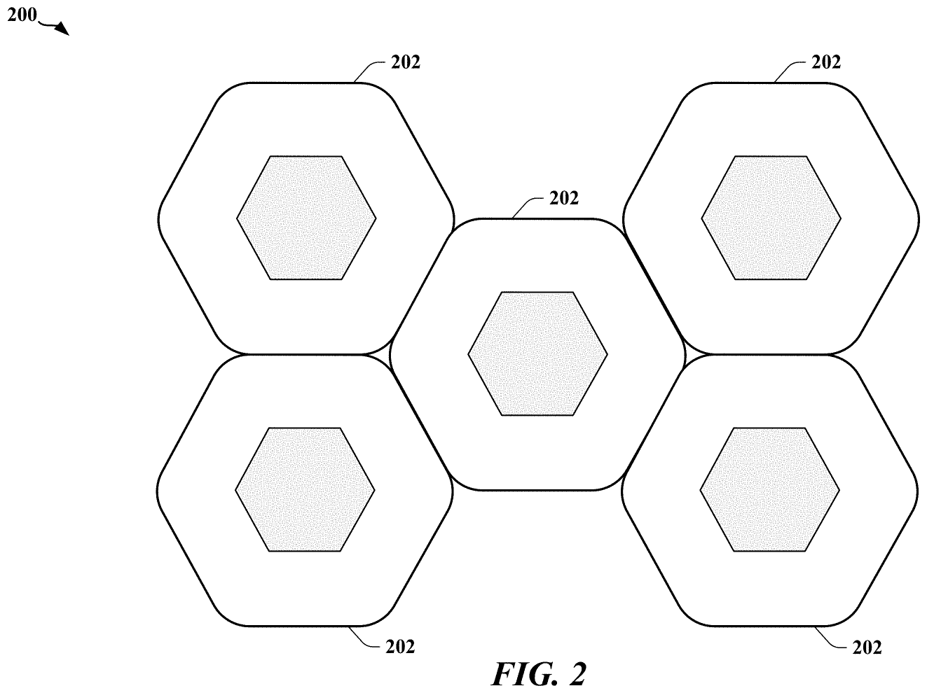

FIG. 2 illustrates an example of an arrangement 200 of charging cells 202 provided on a single layer of a segment or portion of a charging surface that may be included in a charging system that has been adapted in accordance with certain aspects disclosed herein. The charging cells 202 are arranged according to a honeycomb packaging configuration. In this example, the charging cells 202 are arranged end-to-end without overlap. This arrangement can be provided without through-holes or wire interconnects. Other arrangements are possible, including arrangements in which some portion of the charging cells 202 overlap. For example, wires of two or more coils may be interleaved, arranged concentrically or overlaid to some extent.

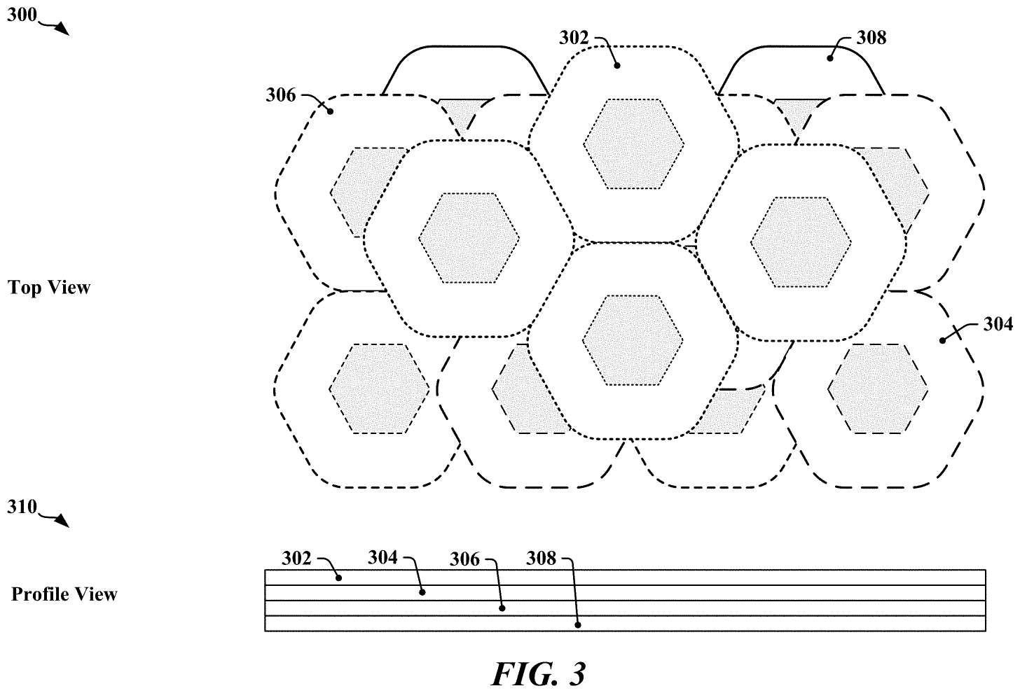

FIG. 3 illustrates an example of an arrangement of charging cells from two perspectives 300, 310 when multiple layers are overlaid within a segment or portion of a charging surface that may be adapted in accordance with certain aspects disclosed herein. In this example, four layers of charging cells 302, 304, 306, 308 are provided within the charging surface. The charging cells within each layer of charging cells 302, 304, 306, 308 are arranged according to a honeycomb packaging configuration. In one example, the layers of charging cells 302, 304, 306, 308 may be formed on a printed circuit board that has four or more copper layers. The arrangement of charging cells 100 can be selected to provide complete coverage of a designated charging area that is adjacent to the illustrated segment.

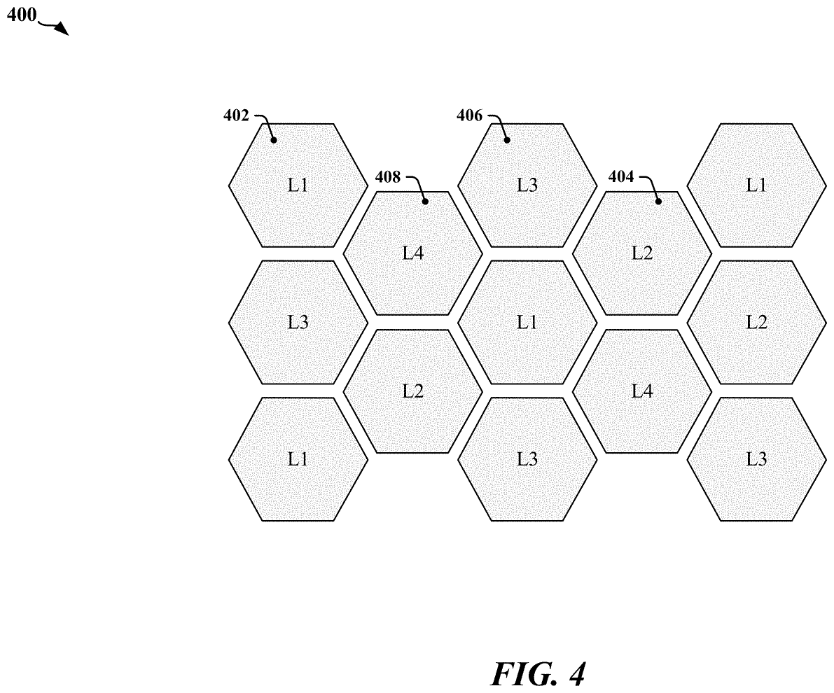

FIG. 4 illustrates the arrangement of power transfer areas defined or configured in a charging surface 400 provided by a charging system in accordance with certain aspects disclosed herein. The illustrated charging surface 400 is constructed using four layers of charging cells 402, 404, 406, 408. In FIG. 4, each power transfer area provided by a charging cell in the first layer of charging cells 402 is marked “L1”, each power transfer area provided by a charging cell in the second layer of charging cells 404 is marked “L2”, each power transfer area provided by a charging cell in the third layer of charging cells 406 is marked “L3”, and each power transfer area provided by a charging cell in the fourth layer of charging cells 408 is marked “L4”.

Wireless Transmitter

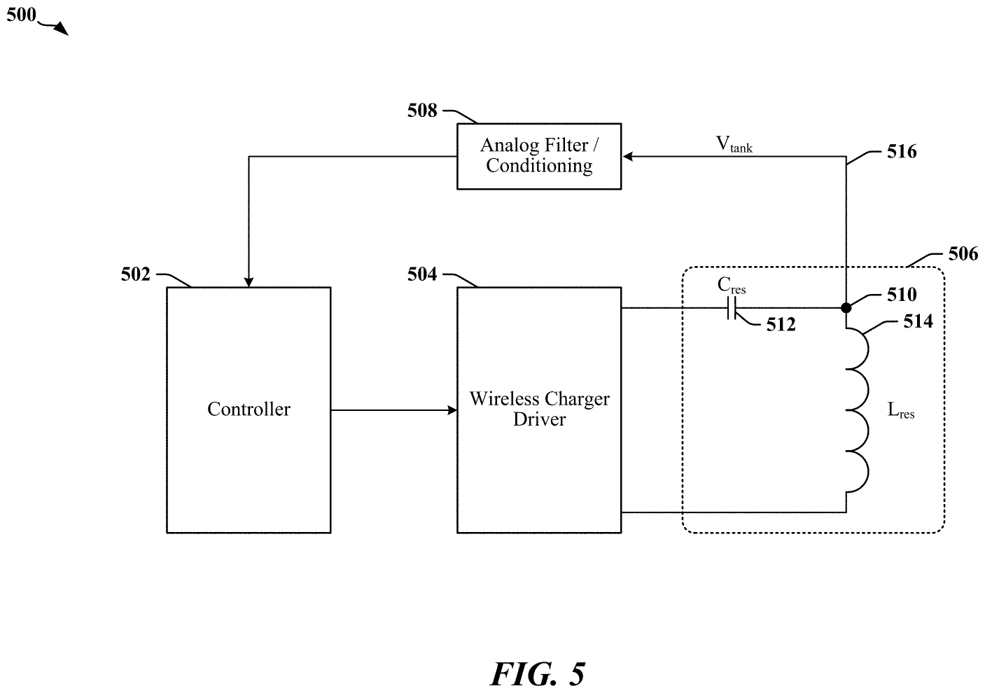

FIG. 5 illustrates certain aspects of a wireless transmitter 500 that can be provided in a base station of a wireless charging device. A base station in a wireless charging device may include one or more processing circuits used to control operations of the wireless charging device. A controller 502 may receive a feedback signal filtered or otherwise processed by a filter circuit 508. The controller may control the operation of a driver circuit 504 that provides an alternating current to a resonant circuit 506. In some examples, the controller 502 generates a digital frequency reference signal used to control the frequency of the alternating current output by the driver circuit 504. In some instances, the digital frequency reference signal may be generated using a programmable counter or the like. In some examples, the driver circuit 504 includes a power inverter circuit and one or more power amplifiers that cooperate to generate the alternating current from a direct current source or input. In some examples, the digital frequency reference signal may be generated by the driver circuit 504 or by another circuit. The resonant circuit 506 includes a capacitor 512 and inductor 514. The inductor 514 may represent or include one or more transmitting coils in a charging cell that produced a magnetic flux responsive to the alternating current. The resonant circuit 506 may also be referred to herein as a tank circuit, LC tank circuit, or LC tank, and the voltage 516 measured at an LC node 510 of the resonant circuit 506 may be referred to as the tank voltage.

Passive ping techniques may use the voltage and/or current measured or observed at the LC node 510 to identify the presence of a receiving coil in proximity to the charging pad of a device adapted in accordance with certain aspects disclosed herein. Some conventional wireless charging devices include circuits that measure voltage at the LC node 510 of the resonant circuit 506 or the current in the resonant circuit 506. These voltages and currents may be monitored for power regulation purposes and/or to support communication between devices. According to certain aspects of this disclosure, voltage at the LC node 510 in the wireless transmitter 500 illustrated in FIG. 5 may be monitored to support passive ping techniques that can detect presence of a chargeable device or other object based on response of the resonant circuit 506 to a short burst of energy (the ping) transmitted through the resonant circuit 506.

A passive ping discovery technique may be used to provide fast, low-power discovery. A passive ping may be produced by driving a low-energy, fast pulse through a network that includes the resonant circuit 506 with a fast pulse that includes a small amount of energy. The fast pulse excites the resonant circuit 506 and causes the network to oscillate at its natural resonant frequency until the injected energy decays and is dissipated. The response of a resonant circuit 506 to a fast pulse may be determined in part by the resonant frequency of the resonant LC circuit. A response of the resonant circuit 506 to a passive ping that has initial voltage=V₀ may be represented by the voltage V_{LC} observed at the LC node 510, such that:

$${V}_{LC} = {V}_{0} {e}^{- ( \frac{ω}{2 Q} ) t} \qquad ( Eq . 1 )$$

The resonant circuit 506 may be monitored when the controller 502 or another processor is using digital pings to detect presence of objects. A digital ping is produced by driving the resonant circuit 506 for a period of time. The resonant circuit 506 is a tuned network that includes a transmitting coil of the wireless charging device. A receiving device may modulate the voltage or current observed in the resonant circuit 506 by modifying the impedance presented by its power receiving circuit in accordance with signaling state of a modulating signal. The controller 502 or other processor then waits for a data modulated response that indicates that a receiving device is nearby.

Selectively Activating Coils

According to certain aspects disclosed herein, power transmitting coils in one or more charging cells may be selectively activated to provide an optimal electromagnetic field for charging a compatible device. In some instances, power transmitting coils may be assigned to charging cells, and some charging cells may overlap other charging cells. The optimal charging configuration may be selected at the charging cell level. In some examples, a charging configuration may include charging cells in a charging surface that are determined to be aligned with or located close to the device to be charged. A controller may activate a single power transmitting coil or a combination of power transmitting coils based on the charging configuration which in turn is based on detection of location of the device to be charged. In some implementations, a wireless charging device may have a driver circuit that can selectively activate one or more power transmitting coils or one or more predefined charging cells during a charging event.

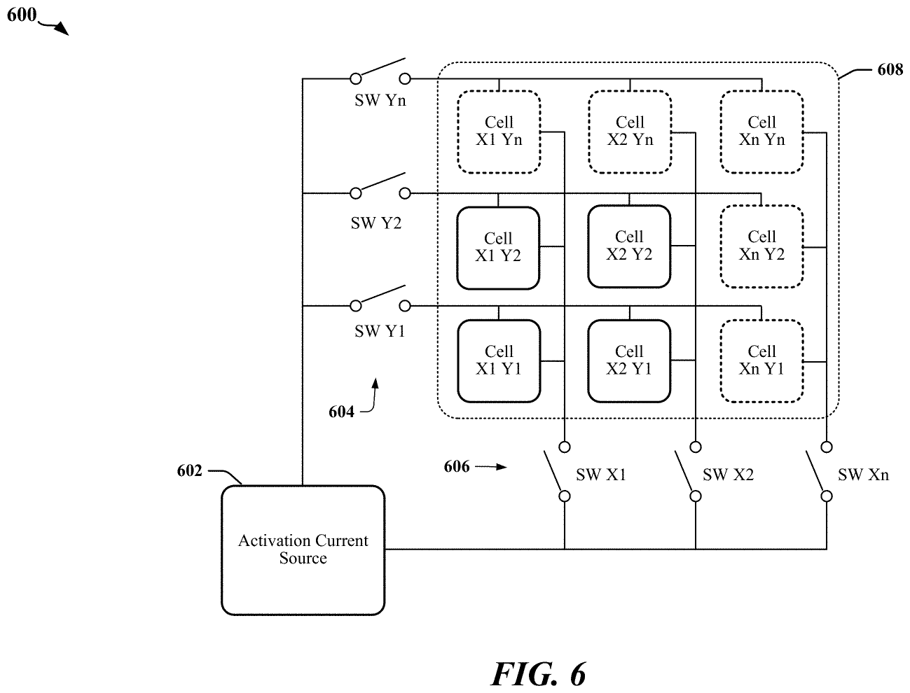

FIG. 6 illustrates a first topology 600 that supports matrix multiplexed switching for use in a wireless charging device adapted in accordance with certain aspects disclosed herein. The wireless charging device may select one or more charging cells 100 to charge a receiving device. Charging cells 100 that are not in use can be disconnected from current flow. A relatively large number of charging cells 100 may be used in the honeycomb packaging configuration illustrated in FIGS. 2 and 3, requiring a corresponding number of switches. According to certain aspects disclosed herein, the charging cells 100 may be logically arranged in a matrix 608 having multiple cells connected to two or more switches that enable specific cells to be powered. In the illustrated topology 600, a two-dimensional matrix 608 is provided, where the dimensions may be represented by X and Y coordinates. Each of a first set of switches 606 is configured to selectively couple a first terminal of each cell in a column of cells to a first terminal of a voltage or current source 602 that provides current to activate coils in one or more charging cells during wireless charging. Each of a second set of switches 604 is configured to selectively couple a second terminal of each cell in a row of cells to a second terminal of the voltage or current source 602. A charging cell is active when both terminals of the cell are coupled to the voltage or current source 602.

The use of a matrix 608 can significantly reduce the number of switching components needed to operate a network of tuned LC circuits. For example, N individually connected cells require at least N switches, whereas a two-dimensional matrix 608 having N cells can be operated with √N switches. The use of a matrix 608 can produce significant cost savings and reduce circuit and/or layout complexity. In one example, a 9-cell implementation can be implemented in a 3×3 matrix 608 using 6 switches, saving 3 switches. In another example, a 16-cell implementation can be implemented in a 4×4 matrix 608 using 8 switches, saving 8 switches.

During operation, at least 2 switches are closed to actively couple one coil or charging cell to the voltage or current source 602. Multiple switches can be closed at once in order to facilitate connection of multiple coils or charging cells to the voltage or current source 602. Multiple switches may be closed, for example, to enable modes of operation that drive multiple transmitting coils when transferring power to a receiving device.

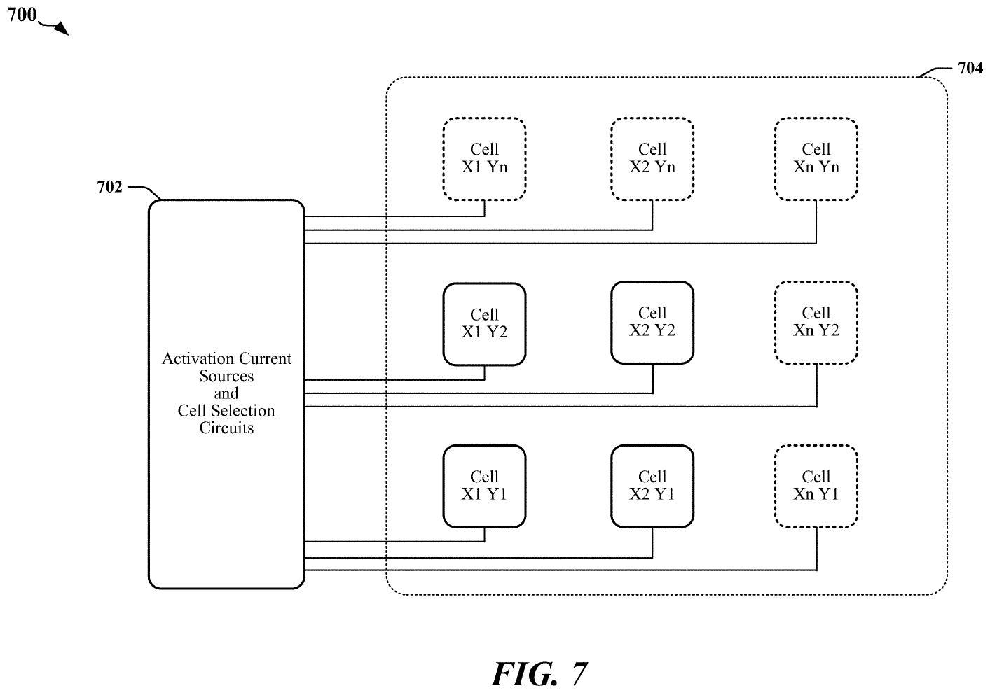

FIG. 7 illustrates a second topology 700 in which each individual coil or charging cell is directly driven by a driver circuit 702 in accordance with certain aspects disclosed herein. The driver circuit 702 may be configured to select one or more coils or charging cells 100 from a group of coils 704 to charge a receiving device. It will be appreciated that the concepts disclosed here in relation to charging cells 100 may be applied to selective activation of individual coils or stacks of coils. Charging cells 100 that are not in use receive no current flow. A relatively large number of charging cells 100 may be in use and a switching matrix may be employed to drive individual coils or groups of coils. In one example, a first switching matrix may configure connections that define a charging cell or group of coils to be used during a charging event and a second switching matrix may be used to activate the charging cell and/or group of selected coils.

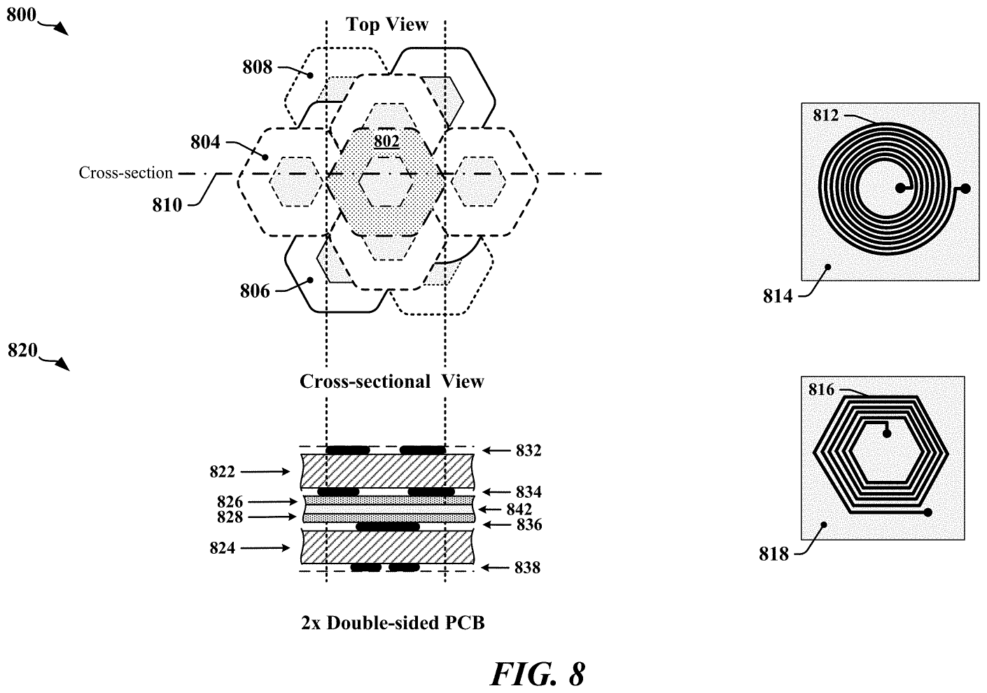

FIG. 8 illustrates a charging cell layout 800 configured in accordance with certain aspects of this disclosure. In the illustrated example, the charging cell layout 800 is provided using a four-layer structure implemented on the metal layers of a pair of two-layer PCBs 822 or 824 that are bonded or joined by an insulating adhesive layer 826. In other examples, the four-layer structure may be implemented on the metal layers of a single four-layer PCB.

In the illustrated example, an active charging cell 802 is provided on a first layer of a four-layer structure and charging cells 804, 806, 808 provided on the other three layers may have windings that overlap the windings of the active charging cell 802. In one example, each charging cell includes a transmitting coil that has a winding formed as a decreasing radius trace 812 or 816 on one side of a PCB 822 or 824. In one example, the decreasing radius trace 812 has a substantially smooth curved spiral shape. In another example, the decreasing radius trace 816 is segmented and generally hexagonal in shape. The decreasing radius traces 812 and 816 may be provided adjacent a magnetic core material 814 and 818, respectively. The magnetic core material 814 and 818 may be formed from a low coercivity material such as a soft ferrite. In one example, the magnetic core material 814 and 818 is integrated in an adhesive layer. In another example, the magnetic core material 814 and 818 may be attached to an adhesive layer or sandwiched between adhesive layers.

A partial view 820 of a lateral cross-section 810 of a pair of two-layer PCBs 822 or 824 illustrates further aspects of charging cell layout 800. In some examples, a charging cell 804 in the second layer, a charging cell 806 in the third layer and a charging cell 808 in the second layer partially overlap the active charging cell 802. Areas of the metal layers 832, 834, 836 and 838 occupied by windings are shown in solid black, with individual traces not being explicitly shown. Each of the metal layers 832, 834, 836 and 838 is provided on a side of a PCB 822 or 824. A planar magnetic core 842 is provided between the two adjacent metal layers 834 and 836 of the PCBs 822 and 824. The planar magnetic core 842 may be included in an adhesive layer or between adhesive layers 826, 828. The planar magnetic core 842 and the adhesive layers 826, 828 are electrically non-conductive.

Challenges facing single-coil and multi-coil wireless charging systems that include transmitting coils formed on PCBs include inefficient power delivery due to the current carrying capabilities of traces that form or supply the transmitting coils, skin effects, eddy currents induced from adjacent windings, and other electromagnetic issues. Skin effect losses occur in traces or wires carrying high frequency signals where the current tends to flow at outermost reaches (skin) of the trace or wire. The concentration of current in the skin of the trace or wire can effectively increase resistance of the trace or wire due to a reduction in the percentage of cross-sectional area of the trace or wire that is used to carry high-frequency AC current. Increasing demands for higher power transfer rates in wireless charging devices can be at least partially met by improving the efficiency of power transmission through the transmitting coils of a wireless charging device. Conventional receiving devices may demand up to 5 W maximum from the transmitter, while next generations of receiving devices can demand 15 W or more to expedite the charging process.

Certain aspects of this disclosure enable wireless charging devices to improve the efficiency of wireless power transfers to receiving devices. Transmitted power may be increased through improvements to transmitting coil design and associated manufacturing techniques. In one example, multiple individual wire-formed transmitting coils may be assembled and maintained in alignment using a substrate that receives the coils in preassigned three-dimensional (3D) locations.

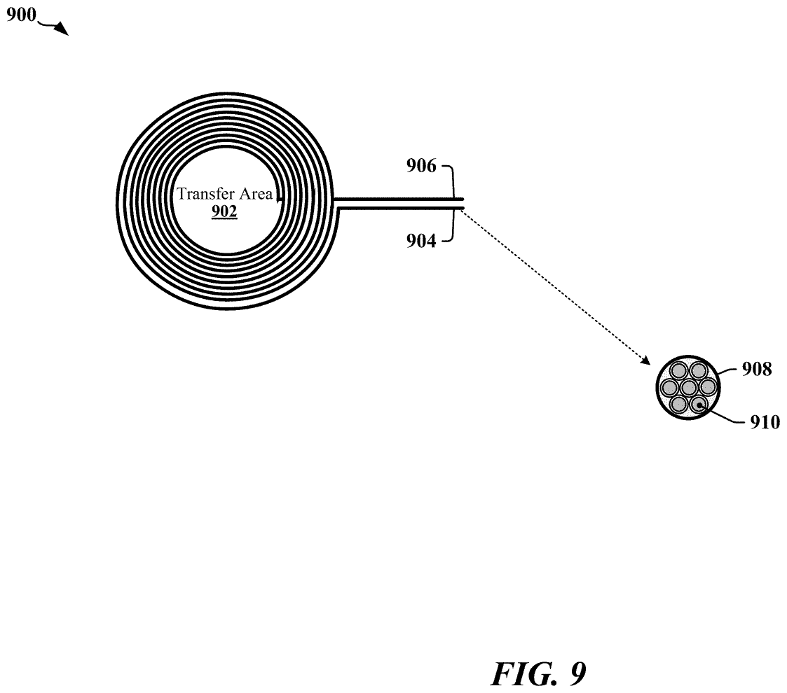

FIG. 9 illustrates an example of a transmitting coil configured in accordance with certain aspects of this disclosure. The transmitting coil may be wound from a multi-stranded Litz wire and each transmitting coil may be connected through wire tails 904, 906 and the transmitting coil may be referred to herein as a Litz coil 900. As can be seen from the cross-sectional view of wire tail 904, each strand 910 of the Litz wire is formed as an insulated conductor that is sufficiently thin to mitigate or substantially reduce skin effect loss. Skin effect losses occur in wires carrying high frequency signals where the current tends to flow at outermost reaches (skin) of the wire. The strands 910 are insulated to maintain their individual nature and are twisted such that the relative positioning of the individual strands 910 changes over the length of the Litz wire. In some instances, the strands 910 are bound by an exterior insulating layer 908. The Litz coil 900 is wound as a substantially planar coil with an open interior that corresponds to the power transfer area 902.

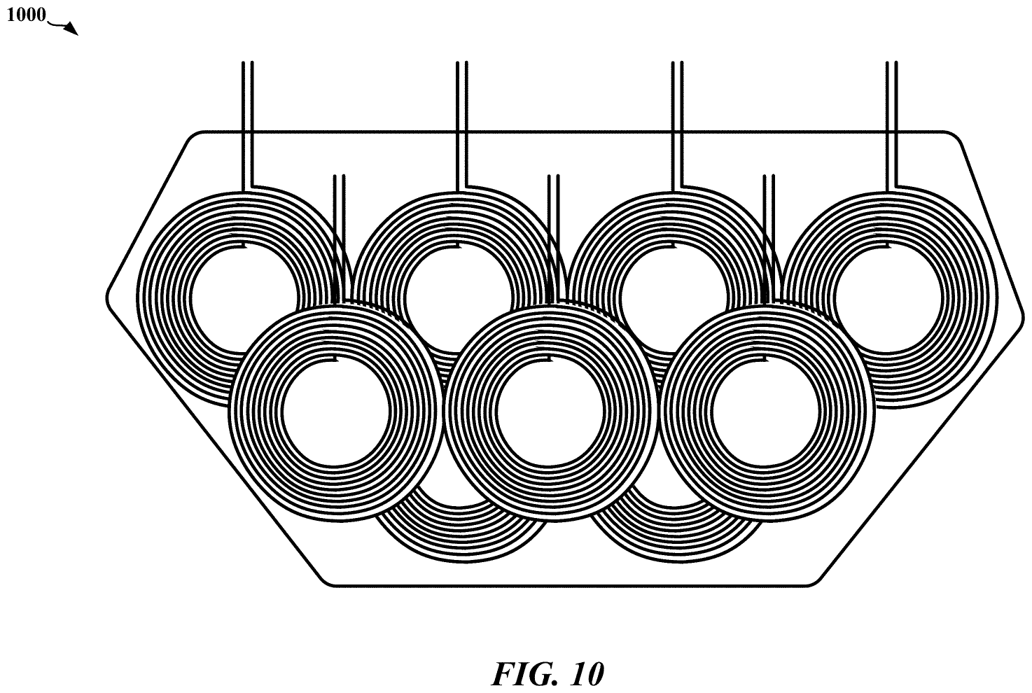

FIG. 10 illustrates an example of Litz coils configured to provide a charging surface in a wireless charging device 1000 provided by multiple overlapping coils. In the illustrated example, each of the coils is a version or copy of the Litz coil 900 of FIG. 9. Three layers of Litz coils 900 are shown to facilitate the illustration of certain aspects of the wireless charging device 1000. In some examples, Litz coils 900 can be arranged in four layers and configured to enable charging of a receiving chargeable device that placed at any available location on the charging surface of the charging device. The number of layers of Litz coils 900 and arrangement of the Litz coils 900 provided in the wireless charging device 1000 may vary according to application, size and shape of the charging surface and power transfer requirements per Litz coil 900.

A wireless charging device 1000 constructed and configured in accordance with certain aspects of this disclosure to ensure full surface charging capability using a charging configuration selected based on the location of a chargeable device on or near the charging surface, location of other chargeable devices or foreign objects on or near the charging surface, physical characteristics of the chargeable device, including number and location of power receiving coils, temperature of the charging surface or chargeable device, and a power transmission level negotiated with the chargeable device or defined by specification. The charging configuration may be selected to optimize power delivery to the chargeable device using one or more Litz coils 900 located in one of multiple layers of coils. Optimizations obtainable through a charging configuration may relate to thermal management, current distribution, magnetic flux concentration and location. Optimizations obtainable through a charging configuration may relate to multiple concurrent charging transactions conducted by the wireless charging device 1000 or through one or more charging surfaces provided by the wireless charging device 1000.

The configuration of Litz coils 900 in relation to a charging surface may be precisely defined by design requirements. The number of Litz coils 900 to be assembled may be difficult to manage and align and variability in positioning of the Litz coils 900 can result in imprecise configurations of coils in some finished devices. In some instances, the Litz coils 900 may be retained in position using an adhesive or epoxy resin. However, the Litz coils 900 must be accurately positioned before application of the adhesive or resin and movement caused during application of the adhesive may affect the operation of the finished wireless charging device. According to certain aspects of this disclosure, a substrate may be provided to receive the Litz coils 900 and maintain the Litz coils 900 in a desired configuration for the lifetime of the wireless charging device.

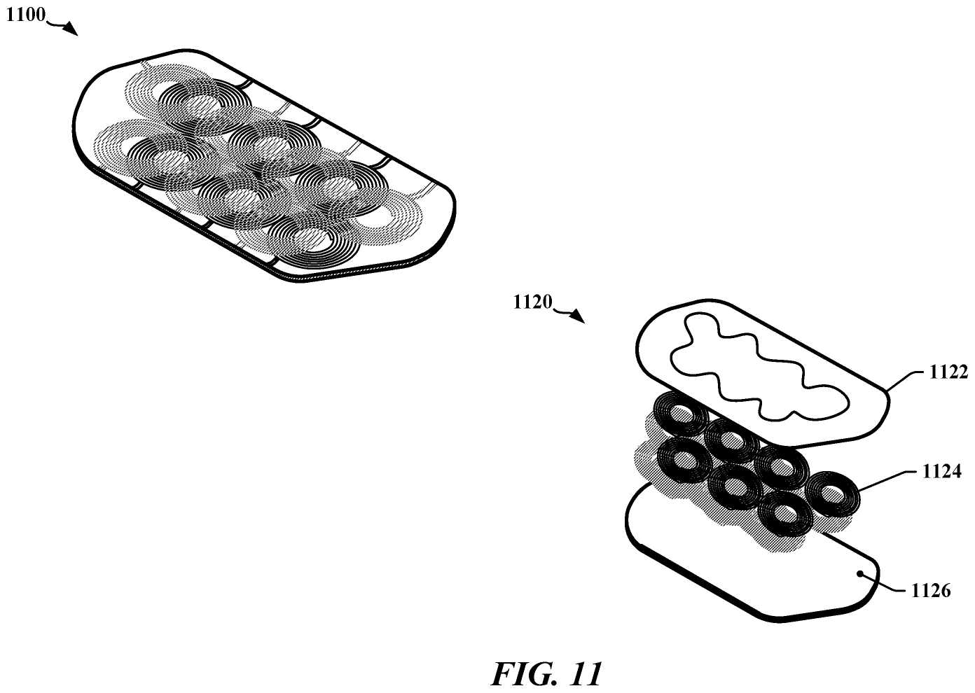

FIG. 11 illustrates charging coils in a wireless charging device 1100 constructed from Litz coils 900 in accordance with certain aspects of this disclosure. The exploded view 1120 shows a Litz coil substrate 1122 configured to receive Litz coils and maintain the Litz coils in a predefined multi-layer Litz coil structure 1124 with 3D displacements between coils that meet tolerances defined by a designer. The Litz coil substrate 1122 may also define the spatial relationship between the multi-layer Litz coil structure 1124 and a ferrite layer 1126 or another type of magnetic material. Mechanical guides and/or channels can be built into the Litz coil substrate 1122 to ensure one-way scalable high-volume manufacturing accuracy of coils. For example, each Litz coil 900 in the multi-layer Litz coil structure 1124 may be inserted in a single orientation in a corresponding cutout, cavity, recess, depression or hollow formed in the Litz coil substrate 1122. When inserted into its assigned location, a Litz coil 900 may be constrained within the three-dimensional space occupied by the Litz coil substrate 1122 and charging surface.

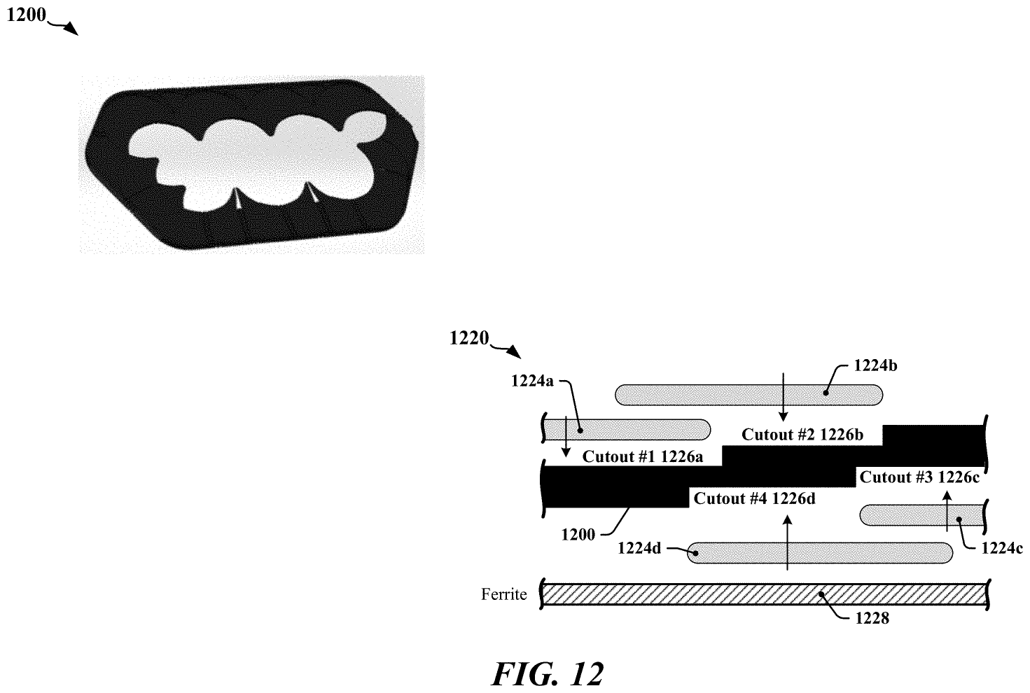

FIG. 12 illustrates certain aspects of a Litz coil substrate 1200 provided in a wireless charging device in accordance with certain aspects of this disclosure. The Litz coil substrate 1200 may include cutouts, cavities, recesses, depressions or hollows that are configured to receive one or more Litz coils 900. The Litz coil substrate 1200 may be formed from a polymer, acetate, vinyl, nitrile rubber, latex, extruded polystyrene foam and/or other material. In some instances, a printed circuit board may be formed, etched, machined or otherwise configured with cutouts, cavities, recesses, depressions or hollows that combine to provide the Litz coil substrate 1200. The Litz coil substrate 1200 may also define the spatial relationship between a multi-layer arrangement of Litz coils and a ferrite layer 1228 or a layer of another type of magnetic material.

According to certain aspects of this disclosure, the Litz coil substrate 1200 may have multiple cutouts that enable the Litz coils 900 to be placed in position in an ordered assembly. In some examples, the cutouts may be preformed when the Litz coil substrate 1200 is manufactured by 3D printing, molding, extrusion and/or low-pressure expansion. In some examples, the cutouts may be formed by milling, grinding, etching, abrading, chemical erosion, chemical dissolution or by another technique suitable for use with the material used to form the Litz coil substrate 1200.

Certain aspects of the Litz coil substrate 1200 are illustrated in a cross-sectional view 1220. The illustrated Litz coil substrate 1200 provides a four-layer charging surface and the cross-sectional view 1220 illustrates an example of placement and assembly of four Litz coils 1224a-1224d. The Litz coil substrate 1200 has a deep, first cutout 1226a in the Litz coil substrate 1200 that receives a first Litz coil 1224a. This first cutout 1226a may be formed as a complete circle in some examples. In other examples, the first cutout 1226a may overlap with another cutout in the same plane of the Litz coil substrate 1200.

When the first Litz coil 1224a has been secured within the first cutout 1226a, a second Litz coil 1224b may be placed in a second cutout 1226b in the Litz coil substrate 1200. When in position within the Litz coil substrate 1200, the second Litz coil 1224b lies in a plane above the plane that includes the first Litz coil 1224a. A portion of the second Litz coil 1224b overlaps a portion of the first Litz coil 1224a. The separation of the planes that include the horizontal center lines of the first Litz coil 1224a and the second Litz coil 1224b may be configured by the relative difference in depths of the first cutout 1226a and the second cutout 1226b.

The third Litz coil 1224c is received by a deep, third cutout 1226c in the Litz coil substrate 1200. This third cutout 1226c may be formed as a complete circle in some examples. In other examples, the third cutout 1226c may overlap with another cutout in the same plane. In one example, third cutout 1226c may partially overlap the first cutout 1226a resulting in a through-hole, when the bottom surface of the first Litz coil 1224a is in the same plane as the top surface or some other portion of the third Litz coil 1224c.

When the third Litz coil 1224c has been secured within the third cutout 1226c, a fourth Litz coil 1224d may be placed in a fourth cutout 1226d. The fourth Litz coil 1224d lies in a plane below the plane that includes the third Litz coil 1224c. A portion of the fourth Litz coil 1224d overlaps a portion of the third Litz coil 1224c when secured within the Litz coil substrate 1200. The separation of the planes that include the horizontal center lines of the third Litz coil 1224c and the fourth Litz coil 1224d may be configured by the relative difference in depths of the third cutout 1226c and the fourth cutout 1226d.

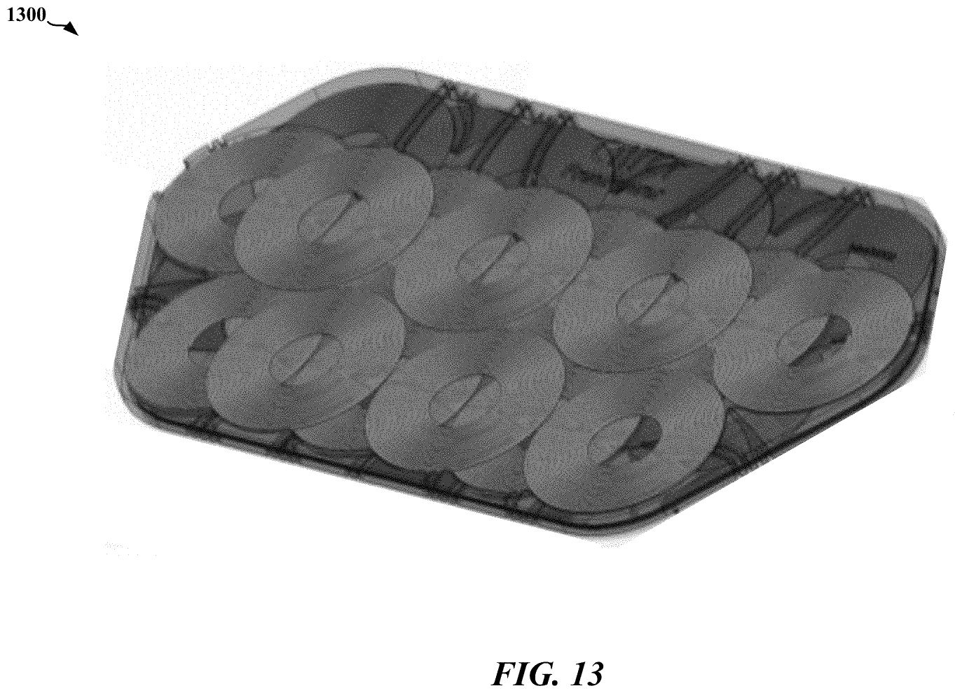

The Litz coil 1224a-1224d may be secured within the Litz coil substrate 1200 through a pressure fit, including when the Litz coil substrate 1200 is manufactured from a foam material. In some examples, the Litz coil 1224a-1224d may be secured within the Litz coil substrate 1200 by adhesive. In some examples, the Litz coil 1224a-1224d may be secured within the Litz coil substrate 1200 by mechanical means. FIG. 13 provides a transparent view 1300 of the Litz coils maintained within a Litz coil substrate in accordance with certain aspects of this disclosure.

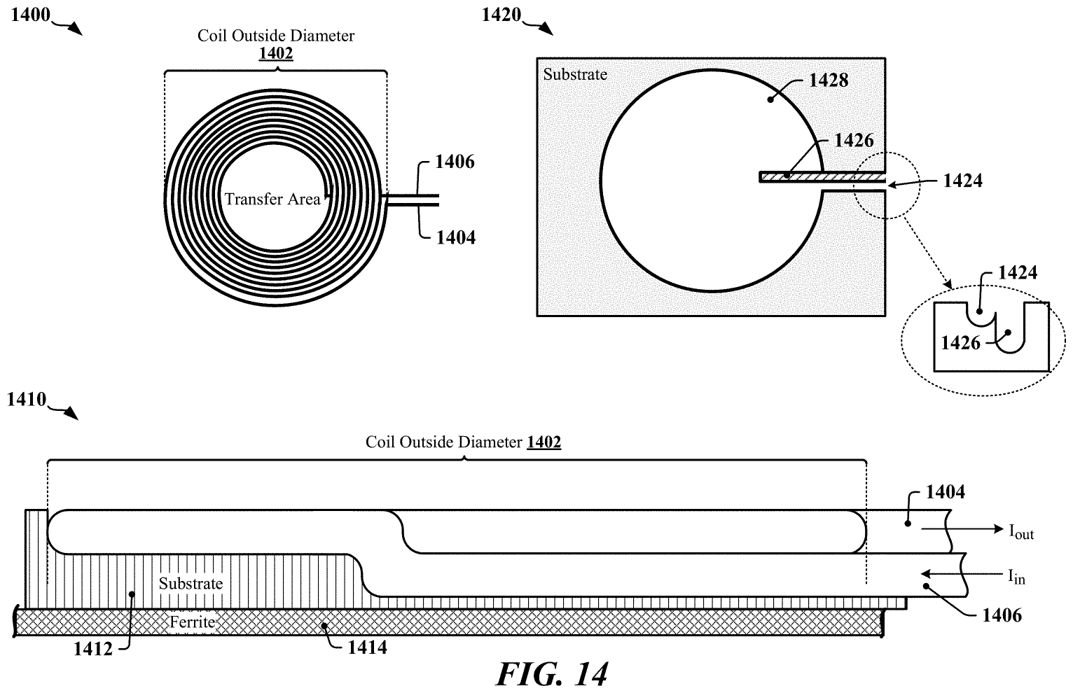

FIG. 14 illustrates placement of a Litz coil 1400 within a portion of a Litz coil substrate 1420 used to provide a charging surface in accordance with certain aspects of this disclosure. The Litz coil 1400 may be received in a cutout, cavity, recess, depression or hollow (referred to collectively herein as a cutout 1428) formed in the Litz coil substrate 1420. The cutout 1428 has a diameter that is selected based on the nominal outside diameter 1402 of the Litz coil 1400. The Litz coil substrate 1420 also includes guides, ducts, through-holes or channels 1424, 1426 configured to carry or retain the wire tails 1404, 1406 of the Litz coil 1400 to connectors, pins, or soldering pads coupled to the transmitting circuits of the wireless charging device. In the illustrated example, one channel 1426 may be extend below or above the Litz coil 1400 to carry a wire tail 1406 that originates at the core of the Litz coil 1400. A cross-section view 1410 showing the Litz coil 1400 illustrates the routing of wire tail 1406 below the Litz coil 1400. The cross-section view 1410 also provides a conceptual representation of the substrate body 1412 and a ferrite layer 1414, here deployed below the substrate body 1412.

In one aspect of the disclosure, a Litz coil substrate can be configured to enable precise physical or mechanical placement of Litz coils with respect to a charging surface. In another aspect of the disclosure, a Litz coil substrate can be configured or manufactured with guides, ducts, through-holes or channels that operate as keying mechanisms that ensure proper electrical connection of the Litz coil to the transmitting circuits of the wireless charging device.

The physical displacement between the channels 1424, 1426 illustrated in FIG. 14 may be sufficient to ensure that the wire tails 1404, 1406 of the Litz coil 1400 are guided to intended termination points or locations at which the wire tails 1404, 1406 are coupled to driver circuits. In some instances, it is possible that the wire tails 1404, 1406 can become twisted at some point such that the intended input of the Litz coil 1400 is connected as an output and the intended output of the Litz coil 1400 is connected as an input. Such erroneous connection would cause an out-of-phase magnetic flux to be generated by the Litz coil 1400 that would tend to cancel or interfere with the magnetic flux generated by other Litz coils used in a charging configuration. Magnetic flux reversal caused by coil misplacement during manufacturing or assembly may be referred to as a phase error, and may render a charging device ineffective or inoperative. The probability of wire routing issues increases during mass production and can result from placement of coils that have been flipped during handling, bending of wire tails 1404, 1406 and other handling issues.

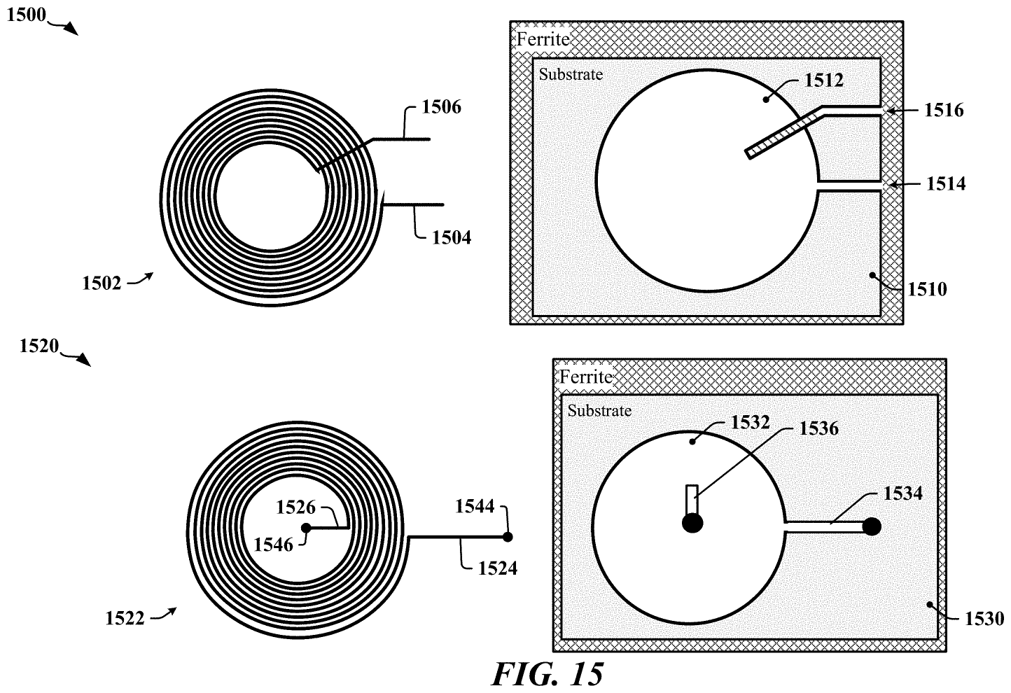

FIG. 15 illustrates examples of substrate configurations 1500, 1520 that have been adapted in accordance with certain aspects of this disclosure, The illustrated substrate configurations 1500, 1520 provide keying mechanisms that can eliminate or minimize the probability of wire routing issues during assembly of a wireless charging device. In each example, a Litz coil 1502, 1522 is received in a cutout, cavity, recess, depression or hollow (referred to collectively herein as a cutout 1512 or 1532) formed in the Litz coil substrate 1510 or 1530. The cutout 1512, 1532 has a diameter that is selected based on the nominal outside diameter or the Litz coil 1502, 1522. The Litz coil substrate 1510 or 1530 also includes guides, ducts, through-holes or channels 1514 and 1516 or 1544 and 1546 that are configured to carry or retain the wire tails 1504 and 1506 of the Litz coil 1502 or the wire tails 1524 and 1526 of the Litz coil 1522. In one example, the channels 1514 and 1516 or 1544 and 1546 may lead to connectors, pins, or soldering pads coupled to the transmitting circuits or diver circuits of the wireless charging device. In the illustrated examples, one channel 1516, 1536 extends or leads below or above the Litz coil 1502 to carry a wire tail 1506 that originates at the center of the Litz coil 1502, 1522 to a termination or coupling point.

In the first example, the Litz coil 1502 has a wire tail 1506 that originates at the core of the coil and angles away from the line to which the other wire tail 1504 is aligned such that a physical separation between the wire tails 1504, 1506 is enforced. The angled wire tail 1506 may be aligned with a radius of the coil layout such that overlap of the wire tail 1506 with of the coil windings is minimized. In some implementations the wire tail 1506 may traverse the coil windings in a direction parallel to the other wire tail 1504 and at a distance of at least a quarter of the radius of the Litz coil 1502. The angle between the wire tails 1504, 1506 may be selected based on design or application needs. In the example illustrated in FIG. 15, an angle between the wire tails 1504, 1506 of approximately 45° is selected. Other implementations provide a 90° angle or an obtuse angle between the wire tails 1504, 1506,

In the second example, the Litz coil 1522 has a wire tail 1526 that originates at the core of the coil and is conducted by means of a through-hole to another layer of the charging surface through the Litz coil substrate 1530. The other wire tail 1524 also passes through the substrate beyond the perimeter of the Litz coil 1522.

The examples of coil assembly provided herein and variants of these examples can enable assembly of Litz coils 1400, 1502, 1522 to be automated and scaled with minimal or no risk of introducing phase errors in magnetic flux generation. Guides, ducts, through-holes or channels 1424, 1426, 1514, 1516, 1544, 1546 configured in accordance with certain aspects of this disclosure can render it practically impossible for coils to be mounted while flipped, rotated or otherwise misaligned during manufacture or assembly of the wireless charging device. Guides, ducts, through-holes or channels 1424, 1426, 1514, 1516, 1544, 1546 can be engineered such that coils fit the substrate when mounted in the correct manner but the substrate assembly is misaligned, misfitting or does not close or lock properly when a coil is improperly inserted.

Example of a Processing Circuit

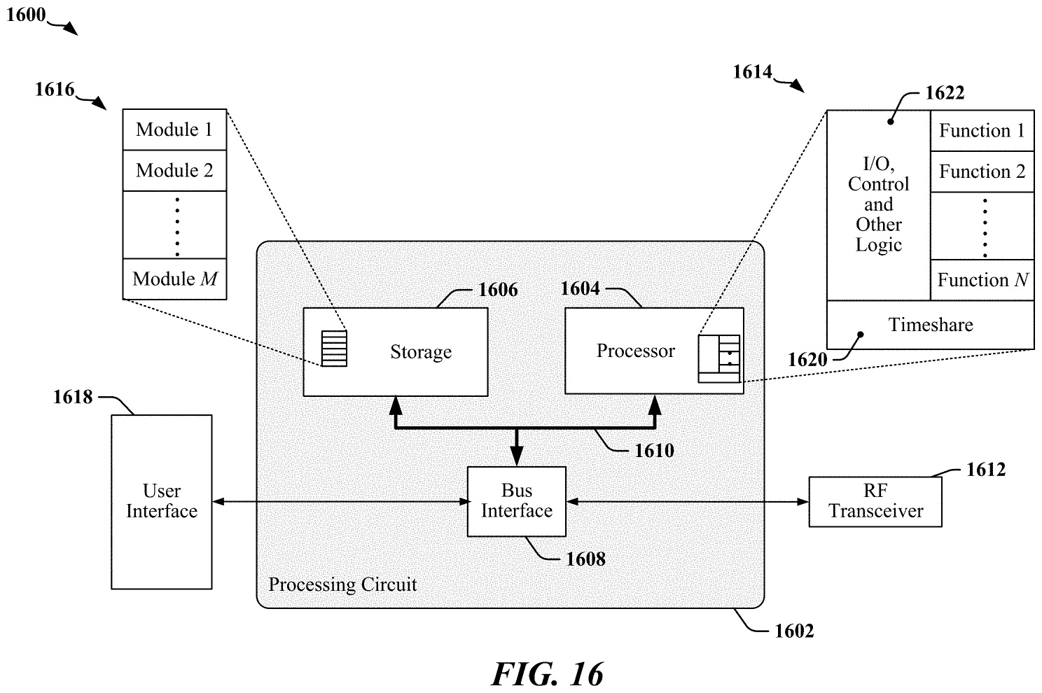

FIG. 16 illustrates an example of a hardware implementation for an apparatus 1600 that may be incorporated in a charging device or in a receiving device that enables a battery to be wirelessly charged. In some examples, the apparatus 1600 may perform one or more functions disclosed herein. In accordance with various aspects of the disclosure, an element, or any portion of an element, or any combination of elements as disclosed herein may be implemented using a processing circuit 1602. The processing circuit 1602 may include one or more processors 1604 that are controlled by some combination of hardware and software modules. Examples of processors 1604 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1604 may include specialized processors that perform specific functions, and that may be configured, augmented or controlled by one of the software modules 1616. The one or more processors 1604 may be configured through a combination of software modules 1616 loaded during initialization, and further configured by loading or unloading one or more software modules 1616 during operation.

In the illustrated example, the processing circuit 1602 may be implemented with a bus architecture, represented generally by the bus 1610. The bus 1610 may include any number of interconnecting buses and bridges depending on the specific application of the processing circuit 1602 and the overall design constraints. The bus 1610 links together various circuits including the one or more processors 1604, and storage 1606. Storage 1606 may include memory devices and mass storage devices, and may be referred to herein as computer-readable media and/or processor-readable media. The storage 1606 may include transitory storage media and/or non-transitory storage media.

The bus 1610 may also link various other circuits such as timing sources, timers, peripherals, voltage regulators, and power management circuits. A bus interface 1608 may provide an interface between the bus 1610 and one or more transceivers 1612. In one example, a transceiver 1612 may be provided to enable the apparatus 1600 to communicate with a charging or receiving device in accordance with a standards-defined protocol. Depending upon the nature of the apparatus 1600, a user interface 1618 (e.g., keypad, display, speaker, microphone, joystick) may also be provided, and may be communicatively coupled to the bus 1610 directly or through the bus interface 1608.

A processor 1604 may be responsible for managing the bus 1610 and for general processing that may include the execution of software stored in a computer-readable medium that may include the storage 1606. In this respect, the processing circuit 1602, including the processor 1604, may be used to implement any of the methods, functions and techniques disclosed herein. The storage 1606 may be used for storing data that is manipulated by the processor 1604 when executing software, and the software may be configured to implement any one of the methods disclosed herein.

One or more processors 1604 in the processing circuit 1602 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1606 or in an external computer-readable medium. The external computer-readable medium and/or storage 1606 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1606 may also include, by way of example, a carrier wave, a transmission line, and any other suitable medium for transmitting software and/or instructions that may be accessed and read by a computer. Computer-readable medium and/or the storage 1606 may reside in the processing circuit 1602, in the processor 1604, external to the processing circuit 1602, or be distributed across multiple entities including the processing circuit 1602. The computer-readable medium and/or storage 1606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1606 may maintain and/or organize software in loadable code segments, modules, applications, programs, etc., which may be referred to herein as software modules 1616. Each of the software modules 1616 may include instructions and data that, when installed or loaded on the processing circuit 1602 and executed by the one or more processors 1604, contribute to a run-time image 1614 that controls the operation of the one or more processors 1604. When executed, certain instructions may cause the processing circuit 1602 to perform functions in accordance with certain methods, algorithms and processes described herein.

Some of the software modules 1616 may be loaded during initialization of the processing circuit 1602, and these software modules 1616 may configure the processing circuit 1602 to enable performance of the various functions disclosed herein. For example, some software modules 1616 may configure internal devices and/or logic circuits 1622 of the processor 1604, and may manage access to external devices such as a transceiver 1612, the bus interface 1608, the user interface 1618, timers, mathematical coprocessors, and so on. The software modules 1616 may include a control program and/or an operating system that interacts with interrupt handlers and device drivers, and that controls access to various resources provided by the processing circuit 1602. The resources may include memory, processing time, access to a transceiver 1612, the user interface 1618, and so on.

One or more processors 1604 of the processing circuit 1602 may be multifunctional, whereby some of the software modules 1616 are loaded and configured to perform different functions or different instances of the same function. The one or more processors 1604 may additionally be adapted to manage background tasks initiated in response to inputs from the user interface 1618, the transceiver 1612, and device drivers, for example. To support the performance of multiple functions, the one or more processors 1604 may be configured to provide a multitasking environment, whereby each of a plurality of functions is implemented as a set of tasks serviced by the one or more processors 1604 as needed or desired. In one example, the multitasking environment may be implemented using a timesharing program 1620 that passes control of a processor 1604 between different tasks, whereby each task returns control of the one or more processors 1604 to the timesharing program 1620 upon completion of any outstanding operations and/or in response to an input such as an interrupt. When a task has control of the one or more processors 1604, the processing circuit is effectively specialized for the purposes addressed by the function associated with the controlling task. The timesharing program 1620 may include an operating system, a main loop that transfers control on a round-robin basis, a function that allocates control of the one or more processors 1604 in accordance with a prioritization of the functions, and/or an interrupt driven main loop that responds to external events by providing control of the one or more processors 1604 to a handling function.

In one implementation, the apparatus 1600 includes or operates as a wireless charging device that has a battery charging power source coupled to a charging circuit, a plurality of charging cells and a controller, which may be included in one or more processors 1604. The plurality of charging cells may be configured to provide a charging surface. At least one coil may be configured to direct an electromagnetic field through a charge transfer area of each charging cell.

In one example, a wireless charging device has a plurality of planar power transmitting coils, a coil substrate and a driver circuit. Each of the plurality of planar power transmitting coils may be formed as a spiral winding surrounding a power transfer area. In one example, each planar power transmitting coil is formed by spiral winding a multi-strand wire, each strand in the multi-strand wire being electrically insulated from each other strand in the multi-strand wire. The coil substrate may have one or more channels or ducts provided therein. Each channel or duct may be configured to carry a tail end of the multi-strand wire from one of the planar power transmitting coils to a point at which the one planar power transmitting coil is coupled to the driver circuit. The channels or ducts may be arranged in a pattern that permits a single orientation of the desired the one planar power transmitting coil. The coil substrate may have a plurality of cutouts formed therein. The plurality of cutouts may be configured to secure the plurality of planar power transmitting coils in a preconfigured three-dimensional arrangement. The driver circuit may be configured to provide a charging current to one or more of the plurality of planar power transmitting coils when a chargeable device is placed on or near the wireless charging device. In some examples, cutouts merge with at least one channel, at least one duct or at least one through-hole.

In some examples, the preconfigured three-dimensional arrangement provides a charging surface through a top surface of the coil substrate as a combination of power transfer areas of the plurality of planar power transmitting coils. A ferrite layer may be provided adjacent to a bottom surface of the coil substrate.

In some examples, the preconfigured three-dimensional arrangement provides planar power transmitting coils in a plurality of vertical planes. The preconfigured three-dimensional arrangement may provide an overlap of a first planar power transmitting coil with a second planar power transmitting coil. The first planar power transmitting coil and the second planar power transmitting coil may be secured in different vertical planes.

In some examples, the coil substrate is formed from a polymer, acetate, vinyl, nitrile rubber, latex, extruded polystyrene foam. In one example, the coil substrate may be formed from a molded polymer and the plurality of cutouts can be formed in the coil substrate during molding. In another example, the coil substrate is formed by three-dimensional printing, and wherein the plurality of cutouts is formed in the coil substrate during printing. In other examples, the plurality of cutouts is formed milling, grinding, etching, abrading, chemical erosion or chemical dissolution.

In certain aspects of the disclosure, a coil substrate has a plurality of cutouts formed in a preconfigured three-dimensional arrangement within a body of the substrate and one or more channels formed in the body of the substrate. Each of the plurality of cutouts may be configured to secure a planar power transmitting coil that is formed from a multi-strand wire. Each channel may be configured to carry a tail end of the multi-strand wire from an associated planar power transmitting coil to a coupling point. The one or more channels may be arranged in a pattern that permits a single orientation of the associated planar power transmitting coil.

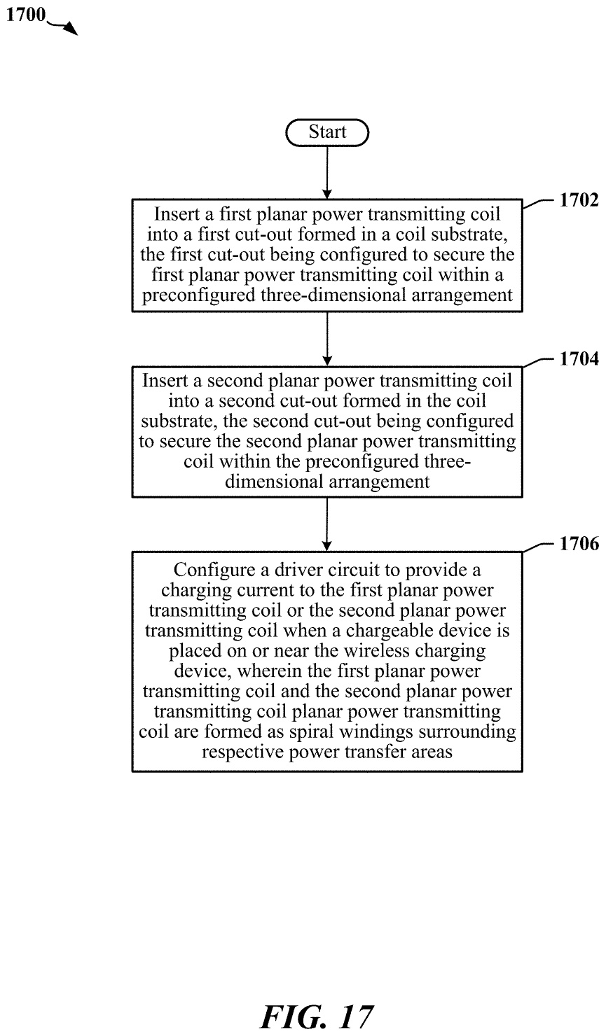

FIG. 17 is a flowchart 1700 illustrating a method for configuring a charging device. At block 1702, a first planar power transmitting coil may be inserted into a first cutout formed in a coil substrate. The first cutout may be configured to secure the first planar power transmitting coil within a preconfigured three-dimensional arrangement. At block 1704, a second planar power transmitting coil may be inserted into a second cutout formed in the coil substrate. The second cutout may be configured to secure the second planar power transmitting coil within the preconfigured three-dimensional arrangement. At block 1706, a driver circuit may be configured to provide a charging current to the first planar power transmitting coil or the second planar power transmitting coil when a chargeable device is placed on or near the wireless charging device. The first planar power transmitting coil and the second planar power transmitting coil may be formed as spiral windings surrounding respective power transfer areas. In one example, the first planar power transmitting coil and the second planar power transmitting coil comprise a multi-strand wire. Each strand in the multi-strand wire may be electrically insulated from each other strand in the multi-strand wire. In this example, the multi-strand wire may be a Litz wire in which the strands are twisted together.

In some examples, the preconfigured three-dimensional arrangement provides a charging surface through a top surface of the coil substrate as a combination of power transfer areas of a plurality of planar power transmitting coils. A ferrite layer may be provided adjacent to a bottom surface of the coil substrate.

In some examples, the preconfigured three-dimensional arrangement provides planar power transmitting coils in a plurality of vertical planes. The preconfigured three-dimensional arrangement may provide an overlap between the first planar power transmitting coil and the second planar power transmitting coil. The first cutout and the second cutout may be provided in different vertical planes.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A wireless charging device, comprising:
a plurality of planar power transmitting coils, each planar power transmitting coil being formed as a spiral winding surrounding a power transfer area;
a coil substrate having a plurality of cutouts formed therein, the plurality of cutouts being configured to secure the plurality of planar power transmitting coils in a preconfigured three-dimensional arrangement; and
a driver circuit configured to provide a charging current to one or more of the plurality of planar power transmitting coils when a chargeable device is placed on or near the wireless charging device.

2. The wireless charging device of claim 1, wherein each planar power transmitting coil is formed by spiral winding a multi-strand wire, each strand in the multi-strand wire being electrically insulated from each other strand in the multi-strand wire.

3. The wireless charging device of claim 2, wherein the coil substrate comprises:
one or more channels or ducts each configured to carry a tail end of the multi-strand wire from one of the planar power transmitting coils to a point at which the one planar power transmitting coil is coupled to the driver circuit.

4. The wireless charging device of claim 3, wherein the channels or ducts are arranged in a pattern that permits a single orientation of the one planar power transmitting coil.

5. The wireless charging device of claim 1, wherein the preconfigured three-dimensional arrangement provides a charging surface through a top surface of the coil substrate as a combination of power transfer areas of the plurality of planar power transmitting coils.

6. The wireless charging device of claim 3, further comprising:
a ferrite layer provided adjacent to a bottom surface of the coil substrate.

7. The wireless charging device of claim 1, wherein the preconfigured three-dimensional arrangement provides planar power transmitting coils in a plurality of vertical planes.

8. The wireless charging device of claim 7, wherein the preconfigured three-dimensional arrangement provides an overlap of a first planar power transmitting coil with a second planar power transmitting coil, and wherein the first planar power transmitting coil and the second planar power transmitting coil are secured in different vertical planes.

9. The wireless charging device of claim 1, wherein the coil substrate is formed from a molded polymer.

10. The wireless charging device of claim 9, wherein the plurality of cutouts is formed in the coil substrate during molding.

11. The wireless charging device of claim 1, wherein the coil substrate is formed by three-dimensional printing, and wherein the plurality of cutouts is formed in the coil substrate during printing.

12. The wireless charging device of claim 1, wherein the coil substrate is formed from formed from a polymer, acetate, vinyl, nitrile rubber, latex, extruded polystyrene foam.

13. The wireless charging device of claim 1, wherein the plurality of cutouts is formed milling, grinding, etching, abrading, chemical erosion or chemical dissolution.

14. A method for configuring a wireless charging device, comprising:
inserting a first planar power transmitting coil into a first cutout formed in a coil substrate, the first cutout being configured to secure the first planar power transmitting coil within a preconfigured three-dimensional arrangement;
inserting a second planar power transmitting coil into a second cutout formed in the coil substrate, the second cutout being configured to secure the second planar power transmitting coil within the preconfigured three-dimensional arrangement; and
configuring a driver circuit to provide a charging current to the first planar power transmitting coil or the second planar power transmitting coil when a chargeable device is placed on or near the wireless charging device,
wherein the first planar power transmitting coil and the second planar power transmitting coil are formed as spiral windings surrounding respective power transfer areas.

15. The method of claim 14, wherein the first planar power transmitting coil and the second planar power transmitting coil comprise a multi-strand wire, each strand in the multi-strand wire being electrically insulated from each other strand in the multi-strand wire.

16. The method of claim 14, wherein the preconfigured three-dimensional arrangement provides a charging surface through a top surface of the coil substrate as a combination of power transfer areas of a plurality of planar power transmitting coils.

17. The method of claim 16, further comprising:
a ferrite layer provided adjacent to a bottom surface of the coil substrate.

18. The method of claim 14, wherein the preconfigured three-dimensional arrangement provides planar power transmitting coils in a plurality of vertical planes.

19. The method of claim 18, wherein the preconfigured three-dimensional arrangement provides an overlap between the first planar power transmitting coil and the second planar power transmitting coil, and wherein the first cutout and the second cutout are provided in different vertical planes.

20. A coil substrate, comprising:
a plurality of cutouts formed in a preconfigured three-dimensional arrangement within a body of the substrate, each of the plurality of cutouts being configured to secure a planar power transmitting coil that is formed from a multi-strand wire; and
one or more channels formed in the body of the substrate, each channel being configured to carry a tail end of the multi-strand wire from an associated planar power transmitting coil to a coupling point,
wherein the one or more channels are arranged in a pattern that permits a single orientation of the associated planar power transmitting coil.
